(19) United States
(12) Patent Application Publication
(10) Pub. No.: US 2021/0116245 A1
(43) Pub. Date: Apr. 22, 2021

(54) DEVICE FOR MEASURING AT LEAST ONE SPEED OF ROTATION OF A HEAD OF A USER ABOUT AN AXIS

(71) Applicant: IXBLUE, Saint-Germain-en-Laye (FR)

(72) Inventors: Frédéric GUATTARI, Saint-Germain-en-Laye (FR); Damien Emmanuel PONCEAU, Saint-Germain-en-Laye (FR)

(21) Appl. No.: 16/956,223

(22) PCT Filed: Dec. 19, 2018
(86) PCT No.: PCT/FR2018/053404

§ 371 Date: Dec. 17, 2020

(30) Foreign Application Priority Data
Dec. 19, 2017 (FR) 1762430

(51) Int. Cl. G01C 19/72; G01C 25/00; G01B 11/26; G02B 27/01; G06F 3/01; G06F 3/0346

(52) U.S. Cl. CPC G01C 19/72; G01C 25/005; G01B 11/26; G02B 27/0176; G02B 27/0172; G02B 2027/0187; G06F 3/012; G06F 3/0346; G02B 2027/0178; G02B 2027/0138; G02B 2027/014; G02B 27/0179

(57) ABSTRACT

The invention relates to a device (70) for measuring at least one speed of rotation of a head (2) of a user about a measurement axis, comprising: a headgear (72) designed to be placed on an ellipsoid body representing the head of the user; a fibre-optic gyrometer comprising at least one coil (73A) made of an optical fibre wound ring-like multiple times around an axis of the coil (z7A). According to the invention, an angle formed between: the central plane of the coil, and a plane tangential to the ellipsoid body in a point situated at the intersection between the ellipsoid body and the coil axis, is smaller than 20 degrees.

### TECHNICAL FIELD OF THE INVENTION

The present invention generally relates to a device for measuring at least one speed of rotation of a head about an axis.

More particularly, it relates to such a device, comprising a fibre-optic gyrometer.

It applies in a particularly interesting way to an “augmented-reality” display helmet or pair of glasses for displaying, in a field of view of the user, information in visual overlay on his/her environment.

It also advantageously applies to a “virtual-reality” display helmet or pair of glasses for displaying, in a field of view of the user, an image of a virtual environment in which the user would move. It also advantageously applies to a “mixed-reality” display helmet or pair of glasses for displaying, in the visual environment of the user, synthesis images simulating the presence of three-dimensional objects.

It also interestingly applies to a sighting device, or to an advanced man-machine interface taking into account the orientation of the head of a user of the interface.

More generally, it advantageously applies to the tracking of the user's head orientation.

### BACKGROUND INFORMATION AND PRIOR ART

It is known from document U.S. Pat. No. 9,213,185 glasses which comprise a gyrometer, for example a fibre-optic gyrometer or a gyrometer of the MEMS (“MicroElectroMechanical System”) type. These glasses comprise a display device for displaying an “augmented-reality” image. The display device is configured to adjust the position of this image as a function of a movement of the glasses determined using the gyrometer.

On the frame of these glasses, the space available for receiving the display device and the gyrometer is limited. In this system, the gyrometer must hence be small and, if possible, light weight. It must also have a high measurement sensitivity, to be able to accurately measure a rotation, even a slow rotation, of the user's head.

In this case, to miniaturize a fibre-optic gyrometer, it is known to reduce the diameter of its fibre coil. Concomitantly, the number of turns of the coil is increased so that the gyrometer keeps a high measurement sensitivity. Indeed, this measurement sensitivity depends directly on the surface enclosed by the optical fibre, which is equal to the surface delimited by a turn of the coil, multiplied by the number of turns of this coil.

The so-obtained fibre coil, compact and rather tick, then occupies a cylindrical volume whose height is comparable to the radius, due to the great number of turns of the coil. By way of example, among the currently available miniature fibre-optic gyrometers, one of the smallest comprises a fibre coil of about 2 centimetres in diameter and 1 centimetre in height.

Despite the reduced size of such a fibre-optic gyrometer, mounting it on glasses harms the balance of the glasses and make them far bulkier.

### SUMMARY OF THE INVENTION

To remedy the above-mentioned drawbacks, the invention proposes a device for measuring at least one speed of rotation of a head of a user about a measurement axis, comprising:

a headgear designed to be placed on an ellipsoid representative of the head of the user,

a fibre-optic gyrometer comprising at least one coil made of an optical fibre wound several times into a ring shape about an axis of the coil to form several turns, the coil being centred to its axis, a mean plane of the coil, parallel to said turns, being perpendicular to the coil axis, the coil axis being parallel to said measurement axis, the coil being fastened to the headgear.

According to the invention, an angle formed between:

the mean plane of the coil, and

a plane tangential to said ellipsoid at a point located at the intersection between the ellipsoid and the coil axis, is smaller than 20 degrees.

When the headgear is placed on the user's head, the coil hence extends substantially parallel to the plane tangential to the portion of the user's head that is located opposite the coil.

This coil arrangement favours a bearing of the coil on the user's head, and hence improves the mechanical stability of the device. In particular, it allows the coil to conform the user's head, which leads to an optimum mechanical stability of the device.

This arrangement moreover allows increasing an external diameter of the fibre coil, which is interesting in terms of measurement sensitivity, without increasing that way the bulk of the device installed on the user's head since the coil and the user's head are, in a certain manner, superimposed to each other.

According to a non-limitative feature of the device according to the invention, it is moreover provided that the external diameter of said coil is greater than 5 centimetres, or even greater than 8 centimetres.

Such a great-diameter fibre coil seems, at first sight, bulky. But, as the surface of a turn of this coil is very extended, it is possible to reduce the number of turns of the coil, and hence the height thereof, while keeping a high measurement sensitivity.

Using that way a coil of great external diameter hence allows, while keeping a high measurement sensitivity, providing this coil with a planar shape particularly favourable in terms of bulk and mechanical stability of the device. Indeed, due to its size, such a coil conforms even better the shape of the user's head, by protruding only slightly with respect to the user's head or with respect to the headgear.

As regards the coil shape, it is moreover optionally provided that its height is smaller than 10 millimetres, or even smaller than 5 millimetres.

It is also provided that the coil height is smaller than one tenth of the external diameter thereof.

According to another, non-limitative, feature of the device according to the invention, an internal diameter of the coil is greater than 4 centimetres.

The ring-shaped coil then has a wide central opening, of diameter greater than 4 centimetres, liable to let through a portion of the headgear or a portion of the user's head, which makes it possible to still reduce the device bulk and to improve the mechanical stability thereof.

It is to be noted that the term “headgear” denotes an element or a set of elements designed to conform at least in part said ellipsoid, adapted to be applied on this ellipsoid and mechanically stable when applied on the latter. In practice, the headgear hence conforms the user's head, at least in part, and is mechanically stable when applied on the user's head (even if it means that it is held by a fastening member such as a clamp, a chinstrap or an elastic lace).

Other non-limitative and advantageous features of the measurement device according to the invention, taken individually or according to all the technically possible combinations, are the following:

the headgear is designed to cover said ellipsoid in such a manner that a portion at least of the ellipsoid enters through said at least one coil;

said at least one coil delimits, alone or with one or several additional coils, an opening adapted to be passed through by a portion at least of the user's head when said headgear covers the user's head;

a mean diameter of said opening being greater than or equal to 10 centimetres;

said at least one coil is arranged so that each point of a lower face of this coil is located at less than 2 centimetres from the user's head, when said headgear covers the user's head, the lower face of said coil being the face of this coil that is the closest to the user's head when said headgear covers the user's head;

said at least one coil is integrated at least in part in the headgear;

the gyrometer comprises an additional coil formed of an additional optical fibre wound several times about an axis of the additional coil to form several turns, a mean plane of the additional coil, parallel to said turns, being perpendicular to the additional coil axis;

an additional angle, formed between:
the mean plane of the additional coil, and
an additional plane, tangential to said ellipsoid at a point located at the intersection between the ellipsoid and the additional coil axis,

is smaller than 20 degrees;

said at least one coil and said additional coil cross each other;

the mean plane of said at least one coil and the mean plane of said additional coil form a dihedron whose opening angle is greater than 90 degrees, said coils mainly extending over both sides of this dihedron, respectively;

the axis of said at least one coil is perpendicular to the axis of said additional coil;

the headgear is designed to cover the user's head, in such a manner that the mean plane of said at least one coil, or the mean plane of said additional coil, forms, with the Frankfurt plane of the user's head, an inclination angle smaller than 20 degrees;

the gyrometer comprises an extra coil formed of an extra optical fibre wound several times about an axis of the extra coil to form several turns, a mean plane of the extra coil, parallel to said turns, being perpendicular to the extra coil axis, an extra angle, formed between the mean plane of the extra coil and an extra plane, tangential to said ellipsoid at a point located at the intersection between the ellipsoid and the extra coil axis, being smaller than 20 degrees;

the axis of said at least one coil being perpendicular to the extra coil axis;

the headgear is designed to cover the user's head, in such a manner that the respective mean planes of two coils, among said at least one coil, said additional coil and said extra coil, are perpendicular to the Frankfurt plane of the user's head, and form with the sagittal plane of the user's head pitch angles comprised between 30 degrees and 60 degrees;

the shape or at least one dimension of said headgear can be reversibly changed;

the measurement device further comprises a calibration system, i.e. for calibrating the gyrometer;

the calibration system comprises a display device and a unit for piloting the display device, programmed to execute the following steps:
commanding the display device to display a message inviting the user to make a rotational movement of the head,
determining an angle of rotation of the head, by integrating over time a measurement signal provided by the gyrometer during the rotational movement made by the user,
correcting a coefficient of calibration of the gyrometer as a function of the previously determined angle of rotation;

the measurement device further comprises an image capturing device;

the piloting unit is further programmed to:
acquire a first image and a second image, captured by the image capturing device, before and after, respectively, said rotational movement of the head,
determine another angle of rotation by processing the first image and the second image, and to
correct the coefficient of calibration of the gyrometer as a function, also, of said other angle of rotation.

### DETAILED DESCRIPTION OF AN EXEMPLARY EMBODIMENT

The following description in relation with the appended drawings, given by way of non-limitative example, will allow a good understanding of what the invention consists of and of how it can be implemented. In the appended drawings:

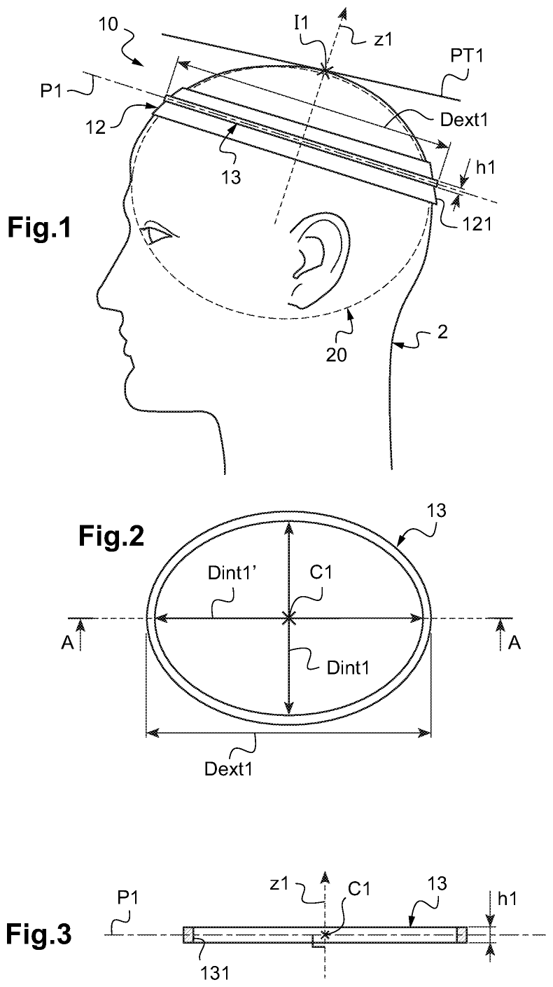

FIGS. 1 to 3 schematically show, in part, a measurement device according to a first embodiment;

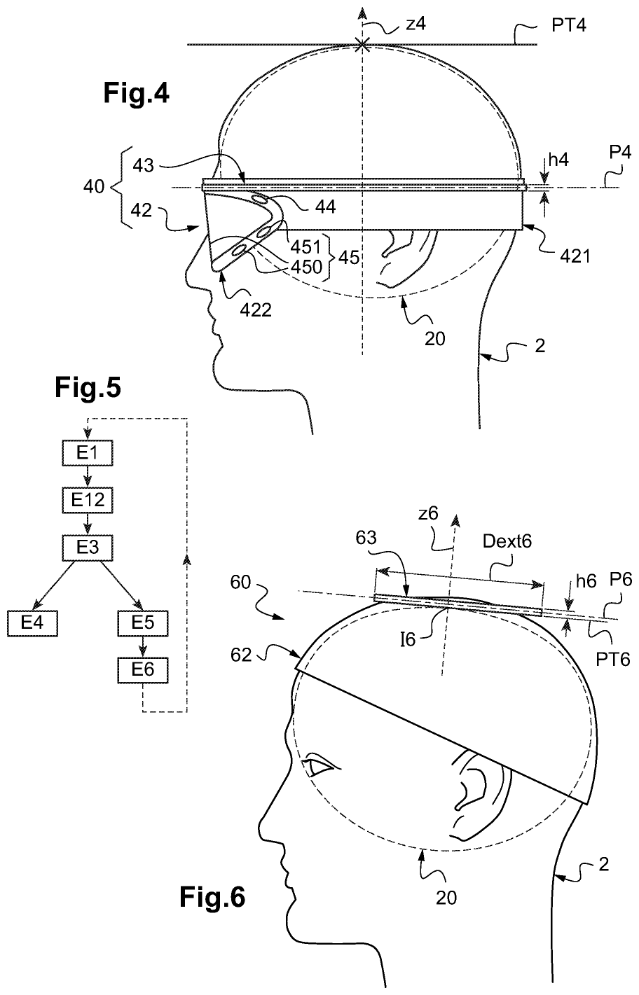

FIG. 4 schematically shows, in part, a measurement device according to a second embodiment;

FIG. 5 schematically shows the main steps of a calibration method implemented in the measurement device of FIG. 4;

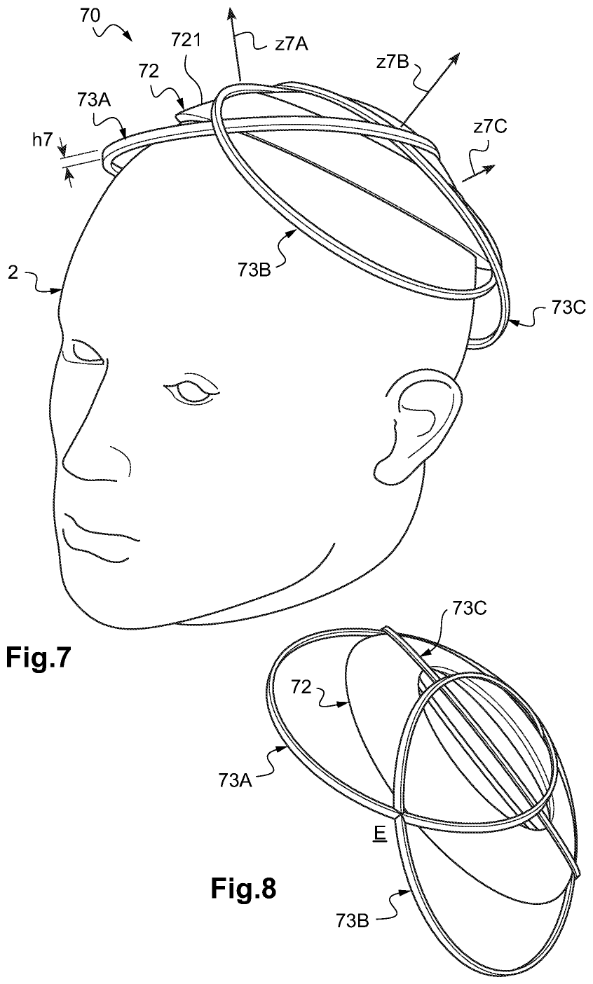

FIG. 6 schematically shows, in part, a measurement device according to a third embodiment;

FIGS. 7 to 9 schematically show, in part, a measurement device according to a fourth embodiment; and

FIGS. 10 to 12 schematically show, in part, a measurement device according to a fifth embodiment.

FIGS. 1 to 11 show five embodiments of a device for measuring at least one speed of rotation of a head 2 of a user about a measurement axis.

Each of the measurement devices comprises a fibre-optic gyrometer comprising at least one coil formed of an optical fibre wound several times into a ring shape.

In the first, second and third embodiments, the gyrometer comprises a single fibre coil. The main differences between these three embodiments relate to the nature of a headgear included in the device, or the positioning of the fibre coil with respect to this headgear.

In the fourth and fifth embodiments, the gyrometer comprises three fibre coils, which makes it possible to measure the speeds of rotation of the user's head 2 about three distinct measurement axes. The main differences between these two embodiments relate to the position of the fibre coils with respect to the headgear of the measurement device.

As can be seen in FIGS. 1, 4, 6, 7 and 10 to 12, in the different embodiments described hereinabove, each coil of the measurement device is located near the user's head, when the device is in position of use on the user's head. In this case, the coil(s) of the measurement device are each arranged so that each point of a lower face of the considered coil is located at less than 2 centimetres of the user's head, when said headgear covers the user's head. For each coil, the lower face of the coil is the face of this coil that is the closest to the users head, when said headgear covers the user's head. Let's consider an ellipsoid 20 representative of the user's head, each coil is hence arranged so that each point of the lower face of said coil is located at less than 2 centimetres from this ellipsoid, when said headgear (12; 42; 62; 72) covers this ellipsoid.

In these different embodiments, the identical or corresponding elements are, as much as possible, denoted by the same reference signs and are not necessarily described each time.

### First Embodiment

FIG. 1 partially shows the measurement device 10 according to the first embodiment of the invention, in position of use on the user's head 2, when viewed from the side (the user's head 2 is seen from the side).

This measurement device 10 comprises a headgear, made as a headband 12. The headband 12 can comprise:

a semi-rigid external portion (for example, made of a semi-rigid plastic material), intended to support a coil 13 of optical fibre of the gyrometer, and

an internal portion to be applied against the user's head 2, which is more flexible, for example made of foam, to be adapted to the shape of the user's head.

This headband 12 has wholly the shape of a ring, here an ellipse. The smallest internal diameter of this ring is greater than or equal to 4 centimetres, preferentially greater than or equal to 10 centimetres. The headband 12 hence has a wide central opening, of diameter at least greater than 4 centimetres (or even greater than 10 centimetres), which allows the headband 12 to be slipped onto the user's head, just like a hairband. A portion of the user's head 2 then passes through the ring formed by the headband 12.

The internal face of the headband 12, intended to come into contact with the user's head 2, conforms the ellipsoid 20 representative of the user's head 2.

This ellipsoid 20 is for example the ellipsoid surface that, on average, conforms at the closest the surface of the user's head 2 comprised between the arch of the eyebrows, the occiput, the left temple and the right temple.

As an alternative, the ellipsoid in question can correspond to a fixed template (independent of the considered user), whose size is representative of the mean size of an adult human skull (or potentially, a child human skull). In this case, the ellipsoid can have, for example: a great diameter comprised between 15 and 25 centimetres, and two other diameters each comprised between 10 and 20 centimetres.

To conform this ellipsoid 20, the internal face of the headband 12 can be concave and/or inclined as a lateral surface of a cone frustum.

The thickness of the headband 12, perpendicular to its internal face, is for example comprised between 1 and 5 millimetres, whereas the width thereof, parallel to its internal face, can be comprised, for example, between about 0.5 and 3 centimetres.

The headband 12 can be held on the head 2 by fastening means (not shown), such as a strap to be passed under the chin (or chinstrap), or a hair clamp.

As already indicated, the measurement device 10 also comprises a fibre-optic gyrometer. The coil 13 of the gyrometer is formed of an optical fibre wound several times into a ring shape about an axis z1 of the coil to form several turns.

The mean plane of the coil P1 is parallel to these turns and extends approximately at mid-height of the coil 13. The coil axis z1 is perpendicular to the mean plane of the coil P1 and passes through the centre C1 of the coil (FIG. 2). The coil centre C1 is the centre of the circular or elliptic contour along which the fibre is wound.

The coil 13 extends all along the circumference of the headband 12. The ring formed by the coil 13 and the ring formed by the headband 12 are hence here almost merged together.

The coil 13 is fastened to the headband 12. It is for example applied to the external surface 121 of the headband 12 (and fastened to this surface by bonding). As a variant, the coil could also be integrated in the thickness of the headband.

The coil 13 is schematically shown in top view in FIG. 2, and in cross-sectional view in FIG. 3 (according to the sectional plane A-A referenced in FIG. 2).

The smallest internal diameter of the coil 13 is greater than or equal to 4 centimetres, preferentially greater than or equal to 10 centimetres (in other words, a cylinder of 4, or even 10 centimetres, of diameter could be inserted through the ring formed by the coil 13).

The coil hence has, like the headband 12, a wide central opening, thanks to which the whole measuring device 10 can be slipped on the user's head 2. In other words, the coil 13 delimits a wide opening, adapted to be passed through by a portion at least of the ellipsoid 20 (in practice, by a portion at least of the user's head 2), when the headgear 12 covers this ellipsoid (in practice, when the headgear 12 covers the user's head 2). The opening in question is here delimited by a circular or elliptic internal edge of the coil, in this case by an internal face 131 of the coil.

The measurement device 10 delimits a free space, surrounded by the fibre coil and by the headgear, great enough to receive a portion at least of the user's head. Instead of being unused, the space surrounded by the fibre is thus usefully used to accommodate a portion of the user's head, which hence reduces the whole bulk of the device when the latter is worn by the user.

The coil 13 has, on the side of its axis z1, the above-mentioned internal face 131, that surrounds this axis, and whose base is here an ellipse. The small diameter Dint1 of this ellipse corresponds to the internal diameter of the above-mentioned coil (FIG. 2). By way of example, the small diameter Dint1 of this ellipse can be equal to about 10 centimetres, the great diameter Dint1′ of this ellipse being equal to about 12 centimetres.

The coil has in addition an external diameter Dext1 greater than or equal to 5 centimetres, preferentially greater than or equal to 11 centimetres.

The surface of a turn of this coil is then very extended, which makes it possible to reduce the number of turns of the coil while keeping a high measurement sensitivity. Reducing this number of turns allows reducing the size of a cross-section of the coil 13.

In the embodiment described herein, the height h1 of the coil is moreover smaller than 5 millimetres. The height h1 is the dimension presented externally by the coil 13, parallel to the coil axis z1.

Thanks to this reduced height, the coil 13 can be fully integrated in the headgear, or, at the very least be applied to the headgear by protruding only slightly with respect to the latter.

By way of example, the cross-section of the coil 13 (ellipse-shaped section perpendicular to the mean line, along which extends the coil) can be squared, the side of this cross-section, which then corresponds to the height h1 of the coil 13, being equal to about 2.5 millimetres. When the optical fibre of the coil has an external diameter of 0.17 mm, 210 turns of this fibre can then be contained in the coil 13. When the above-mentioned small and great diameters Dint1 and Dint1′ are equal to 10 and 12 centimetres, respectively, the total surface enclosed by the optical fibre is then of about 2 square metres, which leads to a measurement sensitivity that is sufficient in practice for many applications.

By way of comparison, to obtain a same enclosed surface of 2 square metres (and hence a same sensitivity), with a coil having a mean diameter of 3 centimetres, a square section of 9 millimetres side should be used, the coil being then thick and bulky.

It will be noted that, due to the conformation of the headband 12 and of the coil 13, the coil 13 extends, in a certain manner, flat with respect to the portion of the head 2 located opposite the coil 13.

More precisely, an angle formed between:

the mean plane of the coil P1, and

a plane PT1, tangential to the ellipsoid 20 that the headband 12 is shaped so as to cover, at a point I1 located at the intersection between the ellipsoid 20 and the coil axis z1,

is smaller than 20 degrees.

Thanks to this arrangement, the whole measurement device 10 has a shape adapted to that of the ellipsoid 20, and protrudes only slightly with respect to the ellipsoid.

The measurement device 10 also comprises, in addition to the coil 13, optical and electronic components necessary to the operation of the gyrometer (not shown).

The gyrometer provides a measurement signal proportional to the speed of rotation of the coil 13 about its axis z1 and/or a signal representative of an angular position of the coil about its axis z1 (obtained by integration over time of the speed of rotation of the coil about its axis z1).

When installed on the user's head 2, the measurement device 10 hence makes it possible to measure a speed of rotation of the head about a measurement axis, which is parallel to the coil axis z1.

### Second Embodiment

FIG. 4 partially shows the measurement device 40 according to the second embodiment of the invention, in position of use on the user's head 2, in side view (the user's head 2 is seen from the side).

In this embodiment, the headgear 42 of the measurement device 40 comprises a glasses frame 422 and a headband 421 for fastening this frame.

The glasses frame 422 is shaped so as to conform the portion of the face of the user 2 that surrounds his/her eyes (in particular, the root and the wings of the nose). The fastening headband 421 connects two temples of the glasses frame 422 and is intended to pass behind the head 2.

The headgear 42 has wholly the shape of a ring, whose smallest internal diameter is greater than or equal to 10 centimetres. It can hence be pushed down on the user's head. In position of use, the headgear 42 surrounds the user's head 2, by conforming the ellipsoid 20 representative of this head 2.

Preferably, the fastening headband 421 is partially flexible and elastic, so that its shape and length are adapted to the shape of the user's head and to his/her skull perimeter. As a variant, the fastening headband could be flexible but inextensible, and comprise adjustment means, such as a loop, to adjust the length of the headgear perimeter to the user's skull perimeter.

The gyrometer of the measurement device 40 here again comprises a coil 43 formed of an optical fibre wound several times into a ring shape about an axis z3 of the coil to form several turns.

The coil 43 extends all over the circumference of the headgear 42 and has hence an external diameter greater than or equal to 10 centimetres. The cross-section of the coil 43 is square, with a side smaller than 5 millimetres. The coil 43 is fastened to the headgear 42. Preferably, the coil 43 is integral with the glasses frame 422, but is not linked to the fastening headband over the whole length of the latter. Thanks to this arrangement, a deformation of the fastening headband (during its adjustment to the user's head) causes only a limited deformation of the coil 43.

As in the first embodiment, the internal diameter of the coil 43 is hence great enough so that the coil can be slipped on the user's head. Here again, the coil 43 delimits an opening adapted to be passed through by a portion at least of the user's head, when the headgear 12 covers his/her head. The opening in question is here again delimited by a circular or elliptic internal edge of the coil.

Similarly to the first embodiment of the invention, it will be noted that the shape of the headgear 42 and of the coil 43 are such that an angle formed between:

the mean plane of the coil P4, and

a plane PT4, tangential to the ellipsoid 20 at a point I4 located at the intersection between the ellipsoid 20 and the axis z4 of the coil,

is smaller than 20 degrees.

The mean plane of the coil P4 and the coil axis z4 are defined in the same way as in the first embodiment described hereinabove.

The measurement device 40 also comprises, in addition to the coil 43, a set of optical and electronic components 44 necessary to the operation of the gyrometer.

The gyrometer provides a measurement signal proportional to the speed of rotation of the coil 43 about its axis z4.

When the measurement device 40 is in position of use on the user's head 2, the mean plane of the coil P4 is approximately parallel to the Frankfurt plane PF relating to the user's head 2. In position of use, the measurement device 40 hence makes it possible to measure a speed of rotation of the head 2 about a measurement axis, parallel to the coil axis z4 that is substantially perpendicular to the Frankfurt plane relating to the user's head, and that passes for example through the first cervical vertebra.

As shown in FIG. 4, and in more details in FIG. 10 (relating to another embodiment), the Frankfurt plane PF is the plane passing through the user's lower orbital points O2 and O3 and porion O1 (the porion being the highest skull point of the auditory canal, which corresponds to the tragion of the ear). When the user is seated or stands up and he/she looks far ahead towards the horizon, the Frankfurt plane PF is approximately horizontal.

The glasses whose frame has been described hereinabove are equipped with an augmented-reality display device 450 for displaying different complementary elements and pieces of information in such a manner that they are overlaid to the user's environment, or to an image of this environment captured by a camera. The camera is integral with the headgear 42.

The display device 450 is piloted by an electronic piloting unit 451.

In this second embodiment, even if the coil 43 is partially decoupled from the fastening headband 421 from a mechanical point of view, an adjustment of the headband is liable to cause a slight deformation of the coil 43. Such a deformation changes the surface area enclosed by the fibre and/or the orientation of the coil axis z4 with respect to the measurement device 40, and hence slightly decalibrates the gyrometer.

To remedy this problem, the measurement device 40 comprises a calibration system 45, for re-calibrating the gyrometer once the measurement device 40 is installed on the user's head.

This calibration system 45 here comprises the display device 450 and the piloting unit 451. The piloting unit 451 is programmed so as to implement a first calibration method described hereinafter, whose main steps are shown in FIG. 5.

During a first step E1, a symbol, such as an arrow or a cross, is displayed at a first display position, by means of the display device 450. This symbol is visually overlaid, for the user, to a remarkable point of the environment that is fixed and easy to visually locate.

At the following step E2, the user rotates his/her head with respect to his/her environment. This rotation is performed in part at least about the measurement axis. Between the beginning and the end of this rotation movement, the user's head has turned by a non-null angle of rotation (potentially a multiple of 360 degrees) about the measurement axis.

To perform this rotational movement, the user can for example, while standing, make one or several turns on himself/herself about the vertical axis, then stand still.

As a variant, the user could make this rotational move by letting his/her shoulders still and by moving the top of his/her skull along an approximately horizontal circle, or along a closed curve, for example figure-eight shaped (this curve extending in an approximately horizontal plane).

During this step, the piloting unit determines a first angle of rotation α1 of the head, by integration over time of the measurement signal provided by the gyrometer. When the gyrometer is calibrated, the first angle of rotation α1 is exactly equal to the angle of which the user's head has rotated, about the measurement axis, during the movement described hereinabove.

At the following step E3, the piloting unit determines a second display position as a function of the first angle of rotation α1. The first position, just as the second display position, are defined in a reference system linked to the display device 40. The second display position is obtained, from the first position, by a rotation of an angle—α1 about the measurement axis (the first and second positions are angularly separated from each other, about the measurement axis, by the angle of rotation determined at step E2).

The symbol is then displayed at the second display position.

When the gyrometer is perfectly calibrated, the symbol is then overlaid, again, to the remarkable point of the environment mentioned hereinabove. If such is the case, the user indicates it to the piloting unit 451, and this first calibration method ends without changing the coefficient of calibration of the gyrometer, at step E4.

When the calibration of the gyrometer is not rigorously exact, the displayed symbol is not exactly overlaid to the remarkable point in question. The user is then invited, at step E5, to rotate his/her head in order to align the symbol with the remarkable point (i.e. to visually overlay them to each other). During this step, the piloting unit determines a second, corrective, angle of rotation α1′, by integrating over time the measurement signal provided by the gyrometer, all along the rotational movement made by the user to restore the alignment between the symbol and the remarkable point.

At the following step E6, the coefficient of calibration of the gyrometer is corrected, as a function of the first angle of rotation α1 and of the second angle of rotation α1′. This coefficient of calibration is a multiplicative coefficient applied to a raw signal produced by the gyrometer to obtain the measurement signal provided by the gyrometer. The measurement signal has values equal to the speed of rotation of the coil about its axis, measured by the gyrometer.

At step E6, the coefficient of calibration is for example corrected by multiplying it by a first corrective coefficient Ccor1, equal to the sum of the first angle of rotation α1 and of the second angle of rotation α1′, divided by the first angle of rotation α1: Ccor1=(α1+α1′)/α1.

After step E6, this first method can either end, or resume at step E1 to correct still more finely, in an iterative way, the coefficient of calibration of the gyrometer.

During this first calibration method, the operations performed by the user are made on demand from the piloting unit 451. For that purpose, the piloting unit commands for example to the display device 450 to display messages such as “turn on yourself”, or “is the symbol aligned with the target?”, or also “turn your head to align the symbol with the target”.

As a variant, the piloting unit 451 could be programmed to execute a second method of calibration of the gyrometer (not shown), that also makes it possible to calibrate the gyrometer (or to correct the calibration thereof) once the latter in place on the user's head.

During this second method, two remarkable points of the environment are used, instead of a single one. These two points are angularly separated, with respect to the centre of the user's head, by a known reference angle αref.

During this second method, the piloting unit invites the user to rotate his/her head about the measurement axis to bring the symbol, initially aligned with the first remarkable point, into alignment with the second remarkable point. An angle of rotation of the head, α2, is then determined by time integration of one of the measurement signals provided by the gyrometer, during the time interval during which the user makes the just-described movement.

The coefficient of calibration of the gyrometer is then corrected as a function of the measured angle of rotation α2 and of the reference angle αref. For that purpose, the coefficient of calibration is for example multiplied by a second correction coefficient Ccor2, equal to the reference angle αref divided by the angle of rotation α2: Ccor2=αref/α2.

As another variant, the piloting unit 451 could be programmed to execute the steps of a third method of calibration of the gyrometer (not shown), also making it possible to calibrate the gyrometer once the latter in place on the user's head.

This third method is based on a processing of at least two images captured by the camera, before and after a rotational movement of the head, respectively. It comprises the steps E1′ to E4′ described hereinafter.

At step E1′, the piloting unit acquires a first image of the user's environment, captured by the camera.

During the following step, E2′, the user rotates his/her head with respect to his/her environment, as in step E2 described hereinabove. During this step, the piloting unit determines an angle of rotation of the head, α3_{G}, by time integration of the measurement signal provided by the gyrometer. This integration is made for the time interval that begins after the capture of the first image, and that ends by the capture of a second image.

At step E3′, the piloting unit acquires the second image of the user's environment, captured by the camera after the user has rotated his head. The piloting unit then determines, by processing the first and second images, another angle of rotation of the head, α3_{C}, used, in a certain manner, as a reference angle of rotation.

At the following step E4′, the piloting unit corrects the coefficient of calibration of the gyrometer, as a function of the angle of rotation α3_{G} and of the other angle of rotation α3_{C}. For that purpose, the coefficient of calibration is for example corrected by multiplying it by a third corrective coefficient Ccor3, equal to said other angle of rotation α3_{c}, divided by the angle of rotation α3_{C}: Ccor3=α3_{C}/α3_{G}.

### Third Embodiment

FIG. 6 partially shows the measurement device 60 according to the third embodiment of the invention, in position of use on the user's head 2, in side view.

This measurement device 60 comprises a headgear, made as a shell 62 that conforms the ellipsoid 20 representative of the user's head. Herein, when the measurement device 60 is placed on the user's head, this shell 62 covers the head from top of the forehead to the occiput.

The measurement device 60 also comprises a gyrometer that includes a coil 63, formed of an optical fibre wound several times into a ring shape about an axis z6 of the coil to form several turns.

This coil 63 forms a circular ring. It has an external diameter Dext6 greater than or equal to 5 centimetres, or even greater than or equal to 11 centimetres, and a height h6 smaller than one tenth of the external diameter Dext6, and in any case smaller than 5 millimetres.

The coil 63 is applied on the external surface of the shell 62, to which it is fastened.

Unlike the first and second embodiments described hereinabove, when this measurement device 60 is placed on the user's head, the coil 63 does not surround the user's head 2.

On the other hand, as hereinabove, an angle formed between:

the mean plane of the coil P6, and

a plane PT6, tangential to the ellipsoid 60 that the shell 12 is shaped so as to cover, at a point I6 located at the intersection between the ellipsoid 20 and the coil axis z6,

is smaller than 20 degrees.

The mean plane of the coil P6 and the coil axis z6 are defined in the same way as for the first embodiment.

The coil 63 hence extends parallel to the portion of the user's head 2 that is located opposite the coil. As illustrated in FIG. 6, this allows the coil to bear, over its whole length, on the user's head, hence making the measurement device extremely mechanically stable and low bulk once installed on the user's head.

As above, the measurement device 60 also comprises, in addition to the coil 63, optical and electronic components necessary to the operation of the gyrometer (not shown).

### Fourth Embodiment

FIG. 7 partially shows the measurement device 70 according to the fourth embodiment of the invention, in position of use on the user's head 2, seen in perspective, the user's head being seen in a three-quarter view.

FIG. 8 substantially corresponds to the same view of the measurement device 70 as in FIG. 7, but without the user's head.

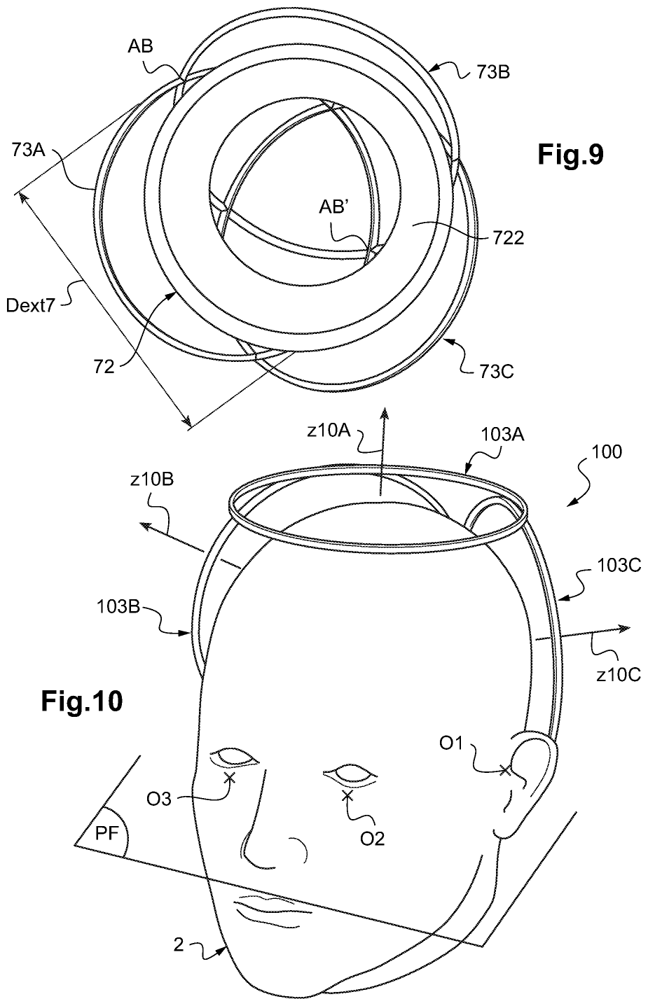

FIG. 9 partially shows the measurement device 70, viewed from the front with respect to the mean plane of a headgear 72 of this device.

This headgear 72 is made in the form of a spherical cap, which is here hollowed out at the top.

The internal face 722 of the headgear, which is inscribed on a sphere, conforms at least in part the ellipsoid 20 representative of the user's head 2. The diameter of the sphere on which is inscribed the internal face 722 of the headgear 72 is such that the headband comes in position about the posterior fontanel when it is applied on the head (FIG. 7).

The headgear 72 has, perpendicularly to its internal face, a thickness comprised, for example, between 1 and 5 millimetres.

The measurement device 70 comprises three coils 73A, 73B and 73C, each formed of an optical fibre wound several times into a ring shape about an axis z7A, z7B, z7C of the coil.

Each of these coils 73A, 73B and 73C forms a circular ring, of external diameter Dext7 greater than or equal to 5 centimetres, or even greater than or equal to 11 centimetres, and a height h7 smaller than one tenth of the external diameter Dext7, and in any case smaller than 5 millimetres.

The respective axes of the three coils z7A, z7B et z7C are directed in three different directions. In this embodiment, these directions are not mutually orthogonal two-by-two. By way of example, they can form, two-by-two, angles of 120 degrees.

A portion of the circumference of each of these coils 73A, 73B, 73C is applied on the external face 721 of the headgear 72, to which the coil is fastened (for example, by bonding).

Each coil is arranged so that its mean plane is inclined by less than 20 degrees with respect to the plane tangential to the ellipsoid at the point of intersection between the coil axis and the ellipsoid (for each coil, the mean plane of the coil and the coil axis are defined in the same way as in the first embodiment).

Each coil hence extends approximately parallel to the portion of the ellipsoid 20 that is located opposite the coil, thanks to what the set of coils conforms the ellipsoid 20.

The measurement device 70 hence delimits, between the fibre coils, a free space E suitable for receiving a portion at least of the user's head (FIG. 8). Instead of being unused, the space surrounded by the set of coils is hence usefully used to accommodate a portion of the user's head.

As can be seen in FIG. 8, the coils 73A, 73B and 73C delimit together an opening adapted to be passed through by a portion at least of the user's head 2 when the headgear 72 covers its head, this opening being wide enough for that purpose. This opening is here delimited by the three-lobed external contour of the set consisted by the thee coils 73A, 73B and 73C. In this case, this opening is delimited by three portions of coils, each having the shape of an arc of a circle, that extend from the crossing points between coils, at the periphery of the device 70. The opening in question (of generally three-lobed shape) has a mean diameter greater than 10 centimetres.

The coils 73A, 73B and 73C cross each other two-by-two. More precisely, the two coils of each couple of coils cross each other at two points (at which they are in contact with each other). By way of example, the coils 73A and 73B cross each other at points AB and AB' denoted in FIG. 9.

As the coils 73A, 73B and 73C cross each other, the respective surfaces delimited by them partly overlap each other. This allows reducing the surface of the user's head covered by the measurement device 70, while using great-diameter coils.

Preferably, for each couple of coils, the respective mean planes of the two coils P7A, P7B, P7C form a dihedron whose opening angle is greater than 90 degrees, or even greater than 110 degrees. The two coils in question mainly extend over both sides of this dihedron, respectively.

The three coils P7A, P7B, P7C then form a kind of flattened three-side pyramid, whose apex angle is greater than 90 degrees. This configuration makes it possible to provide the measurement device 70 with a general shape that conforms at best that of the user's head 2, even when the coils have a relatively small external diameter comprised, for example, between 5 and 11 centimetres.

The centres of the coils are here located at equal distance from each other.

The gyrometer comprises, in addition to the three coils 73A, 73B and 73C, a set of conventional optical and electronic components allowing the operation thereof (not shown).

The gyrometer is hence adapted to determine three speeds of rotation of the head, about the axis z7A of the first coil, the axis z7B of the second coil, and the axis z7C of the third coil, respectively.

Here, the gyrometer is further configured to determine, from these three speeds of rotation, speeds of rotation of the user's head about three other measurement axes, mutually orthogonal two-by-two, one of these other measurement axes being for example perpendicular to the Frankfurt plane relating to the user's head. The gyrometer provides three measurement signals, which have values equal to the three speeds of rotation of the user's head about these three orthogonal measurement axes, respectively.

The measurement device 70 according to this fourth embodiment can comprise a calibration system (not shown), comparable to that of the measurement device 40 of the second embodiment, making it possible to calibrate the gyrometer once the measurement device 70 in position on the user's head.

This calibration system is more precisely configured to correct, if necessary, three coefficients of calibration of the gyrometer associated with the three above-mentioned orthogonal measurement axes, respectively.

This calibration system is configured to execute one of the three calibration methods above-mentioned during the presentation of the second embodiment.

The calibration method in question can be executed three times successively, to correct the three coefficients of calibration of the gyrometer (associated with the three measurement axes), respectively.

In this case, during a first execution of the method, the user is invited to rotate his/her head about the vertical axis (as described hereinabove for the second embodiment of the invention).

On the other hand, during a second execution of the method, the piloting unit invites the user to rotate his/her head upward, or downward, about a horizontal axis, transverse to the head (for example, approximately parallel to the axis passing through the two auditory canals of the user), and no longer about a vertical axis.

Finally, during a third execution of the calibration method, the piloting unit invites the user to incline his/her head towards the left or towards the right, by rotating it about a horizontal axis, approximately orthogonal to the user's face (instead of rotating it about a vertical axis).

### Fifth Embodiment

FIG. 10 partially shows the measurement device 100 according to the fifth embodiment of the invention, in position of use on the user's head 2, seen in perspective, the user's head being seen in a three-quarter view.

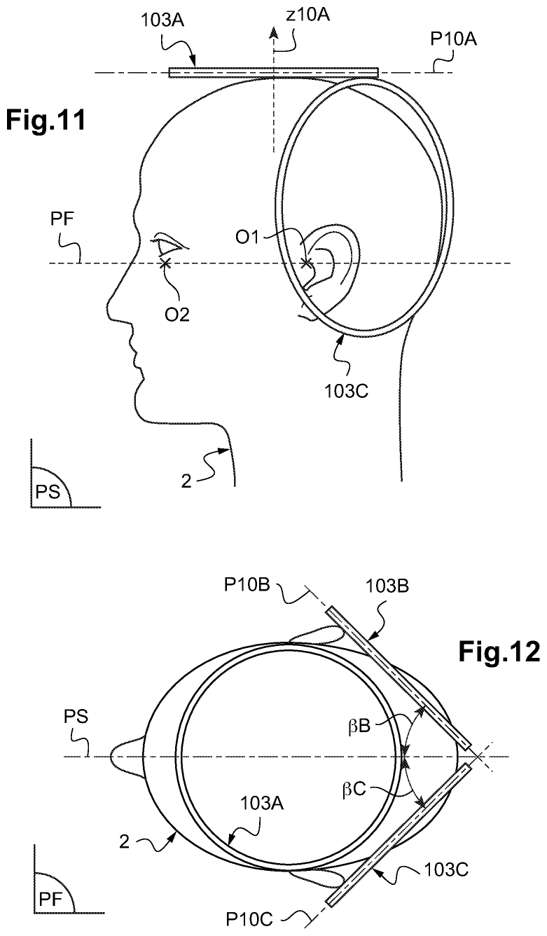

FIGS. 11 and 12 partially show the measurement device 100, seen respectively from the top and from the side with respect to the user's head.

This measurement device 100 here again comprises a headgear (that is not shown in the Figures).

This headgear is made, for example, in the form of a shell, which conforms the ellipsoid 20 representative of the user's head.

In this fifth embodiment, the headgear is shaped so as to take predetermined fixed position and orientation, with respect to the user's head, when it is placed on this head 2, as this is the case, for example, for a bike or motorcycle helmet when the latter is fixed to the head of a user.

The measurement device 100 comprises three coils 103A, 103B and 103C, each formed of an optical fibre wound several times into a ring shape about an axis z10A, z10B, z10C of the coil to form several turns.

Each of these coils 103A, 103B and 103C forms a circular ring, having an external diameter greater than or equal to 5 centimetres, or even greater than or equal to 11 centimetres, and of height smaller than one tenth of the external diameter, and in any case smaller than 5 millimetres.

The respective axes z10A, z1OB and z10C of the three coils are mutually orthogonal two-by-two.

With respect to the fourth embodiment, the fact that the coil axes are mutually orthogonal two-by-two improves the accuracy of measurement of the speeds of rotation of the head about the horizontal measurement axes (z10B, z10C).

Moreover, the fact that the coils are mutually orthogonal two-by-two makes it possible to minimize the influence that a deformation of the headgear, or a lack of initial alignment between the coils (here, a lack of orthogonality), could have on the gyrometer exactitude. More precisely, as the coils are mutually orthogonal two-by-two, a variation of orientation of one of the coil axes (with respect to the others), by a small angle θ, causes only a reduced error of measurement, proportional to squared θ (variation of the second order with respect to the error of alignment θ).

The coils 103A, 103B and 103C are fastened to the headgear.

Like in the other embodiments, each coil 103A, 103B and 103C is arranged so that its mean plane is inclined by less than 20 degrees with respect to the plane tangential to the ellipsoid at the point of intersection between the axis of the coil and the ellipsoid (for each coil, the mean plane of the coil and the coil axis are defined in the same manner as for the first embodiment).

A first one of these coils, 103A, is positioned with respect to the headgear so that the mean plane P10A thereof forms, with the Frankfurt plane PF of the user's head 2, an inclination angle smaller than 20 degrees, when the headgear is placed on the user's head. As shown in the Figures, the measurement device 100 is even shaped so that this inclination angle is null, the first coil 103a hence extending parallel to the Frankfurt plane PF.

When the measurement device is positioned on the user's head, the axis of the first coil, z10A, passes approximately by the centre of the user's head, and the mean plane, P10A, of this coil is located slightly above the top of the user's head (FIG. 11).

The second and third coils 103B and 103 are located on the right rear portion and left rear portion of the head 2, respectively, when the measurement device is in position of use. Their respective mean planes P10B and P10C are both perpendicular to the mean plane P10A of the first coil.

The mean planes of the second and third coils, P10B and P10C, form a first and a second pitch angle βB and βC, respectively, with the sagittal plane PS of the user's head (FIG. 12).

The sagittal plane PS, also called vertical median plane of the head, is the plane orthogonal to the Frankfurt plane PF that contains the right bisector of the segment connecting the respective centres of both eyes.

The first and second pitch angles βB, βC are each comprised between 30 degrees and 60 degrees. As shown in FIG. 12, they are equal to about 45 degrees.

The three coils 103A, 103B and 103C of the gyrometer are here inscribed on the three sides, respectively, of a three-sided pyramid (the three sides being mutually orthogonal two-by-two).

Like in the fourth embodiment, the measurement device 100 delimits, between the coils 103A, 103B and 103C, a free space suitable for usefully receiving a portion at least of the user's head. This free space is of approximately pyramidal shape (FIGS. 10 to 12), the top of the corresponding pyramid being located in the vicinity of the posterior fontanel when the measurement device 100 is in position of use on the user's head 2.

As can be seen in FIGS. 10 to 12, the coils 103A, 103B and 103C delimit together a wide opening, adapted to be passed through by a portion at least of the user's head when the headgear of the device 100 covers his/her head. This opening is here delimited by the external perimeter (i.e. the farthest from the centre of the free space mentioned hereinabove), in a certain manner three-lobed, of the set constituted by the three coils 103A, 103B and 103C. In this case, this opening is delimited by the three coil portions, each having the shape of an arc of a circle or of an arc of an ellipse, and that each extend between two “junction” points of the considered coil. The junction points of the considered coil are the two points of this coil the closest to the two other coils of the device. The opening in question (of generally three-lobed shape) has a mean diameter greater than 10 centimetres.

The measurement device 100 according to this fifth embodiment can comprise a calibration system that is comparable, or even identical, to that of the fourth embodiment.

Different variants may be brought to the just-described five embodiments of the measurement device, in particular as regards the headgear of the measurement device. Indeed, as appears from the whole description, different headgears can be contemplated. For example, in the second embodiment, the headgear could be made in the form of a cap rather than in the form of glasses with a fastening headband. More generally, the headgear can take the shape of any type of headgear available on the market (cap, helmet, hat, hairband, . . . ), compatible with the considered embodiment.

The first and third embodiments can optionally be equipped with a calibration system such as that equipping the measurement device of the second embodiment.

1. A device (10; 40; 60; 70; 100) for measuring as least one speed of rotation of a head (2) of a user about a measurement axis, comprising:
a headgear (12; 42; 62; 72) designed to be placed on an ellipsoid (20) representative of the head (2) of the user;
a fibre-optic gyrometer comprising at least one coil (13; 43; 63; 73A, 73B, 73C; 103A, 103B, 103C) made of an optical fibre wound several times into a ring shape about an axis (z1; z4; z6; z7A, z7B, z7C; z10A, z10B, z10C) of the coil to form several turns, the coil being centred to its axis, a mean plane of the coil (P1; P4; P6; P10A, P10B, P10C), parallel to said turns, being perpendicular to the coil axis, the coil axis being parallel to said measurement axis, the coil being fastened to the headgear, wherein an angle formed between
the mean plane (P1; P4; P6; P10A, P10B, P10C) of the coil, and
a plane (PT1; PT4; PT6) tangential to said ellipsoid (20) at a point (I1; I4; I6) located at the intersection between the ellipsoid and the coil axis,
is smaller than 20 degrees.

2. The measurement device (10; 40; 60; 70; 100) according to claim 1, wherein an external diameter (Dext1; Dext6; Dext7) of said at least one coil (13; 43; 63; 73A, 73B, 73C; 103A, 103B, 103C) is greater than 5 centimeters.

3. The measurement device (10; 40; 60; 70; 100) according to claim 1, wherein a height (h1, h4, h5, h7) of said at least one coil (13; 43; 63; 73A, 73B, 73C; 103A, 103B, 103C) is smaller than 5 millimeters.

4. The measurement device (10; 40; 60; 70; 100) according to claim 1, wherein a height (h1, h4, h5, h7) of said at least one coil (13; 43; 63; 73A, 73B, 73C; 103A, 103B, 103C) is smaller than one tenth of an external diameter (Dext1; Dext6; Dext7) of said at least one coil.

5. The measurement device (10; 40; 60; 70; 100) according to claim 1, wherein an internal diameter (Dint1) of said at least one coil (13; 43; 63; 73A, 73B, 73C; 103A, 103B, 103C) is greater than 4 centimeters.

6. The measurement device (10; 40; 70; 100) according to claim 1, wherein the headgear (12; 42; 62; 72) is designed to cover said ellipsoid (20) in such a manner that a portion at least of the ellipsoid (20) enters through said at least one coil (13; 43; 73A, 73B, 73C; 103B, 103C).

7. The measurement device (10; 40; 70; 100) according to claim 1, wherein said at least one coil (13; 43; 73A, 73B, 73C; 103A, 103B, 103C) delimits, alone or with one or several additional coils (73A, 73B, 73C; 103A, 103B, 103C), an opening adapted to be passed through by a portion at least of the user's head (2) when said headgear (12; 42; 62; 72) covers the user's head (2), a mean diameter of said opening being greater than or equal to 10 centimeters.

8. The measurement device (10; 40; 60; 70; 100) according to claim 1, wherein said at least one coil (13; 43; 73A, 73B, 73C; 103A, 103B, 103C) is arranged so that each point of a lower face of this coil is located at less than 2 centimeters from the user's head (2), when said headgear (12; 42; 62; 72) covers the user's head (2), said lower face being the face of said coil that is the closest to the user's head (2) when said headgear (12; 42; 62; 72) covers the user's head (2).

9. The measurement device (10; 40; 60; 70; 100) according to claim 1, wherein said at least one coil (13) is integrated at least in part in the headgear (12).

10. The measurement device (70; 100) according to claim 1, wherein:
the gyrometer comprises an additional coil (73A, 73B, 73C; 103A, 103B, 103C) formed of an additional optical fibre wound several times about an axis (z7A, z7B, z7C; z10A, z10B, z10C) of the additional coil to form several turns, a mean plane (P10A, P10B, P10C) of the additional coil, parallel to said turns, being perpendicular to the additional coil axis, and wherein
an additional angle, formed between:
the mean plane (P10A, P10B, P101C) of the additional coil, and
an additional plane, tangential to said ellipsoid (20) at a point located at the intersection between the ellipsoid and the additional coil axis (z7A, z7B, z7C; z10A, z10B, z10C), is smaller than 20 degrees.

11. The measurement device (70) according to claim 10, wherein said at least one coil (73A, 73B, 73C) and said additional coil (73A, 73B, 73C) cross each other.

12. The measurement device (70) according to claim 10, wherein the mean plane (P7A, P7B, P7C) of said at least one coil and the mean plane (P7A, P7B, P7C) of said additional coil form a dihedron whose opening angle is greater than 90 degrees, said coils mainly extending over both sides of this dihedron, respectively.

13. The measurement device (100) according to claim 10, wherein:
the axis (z10A, z10B, z10C) of said at least one coil is perpendicular to the axis (z10A, z10B, z10C) of said additional coil, and wherein
the headgear is designed to cover the user's head (2), in such a manner that the mean plane of said at least one coil, or the mean plane of said additional coil (P10A), forms with the Frankfurt plane (PF) of the user's head (2) an inclination angle smaller than 20 degrees.

14. The measurement device (100) according to claim 13, wherein:
the gyrometer comprises an extra coil (103A, 103B, 103C) formed of an extra optical fibre wound several times about an axis (z10A, z10B, z10C) of the extra coil to form several turns, a mean plane (P10A, P10B, P10C) of the extra coil, parallel to said turns, being perpendicular to the extra coil axis, an extra angle, formed between the mean plane (P10A, P10B, P10C) of the extra coil and an extra plane, tangential to said ellipsoid (20) at a point located at the intersection between the ellipsoid and the extra coil axis (z10A, z10B, z10C), being smaller than 20 degrees,
the axis (z10A, z10B, z10C) of said at least one coil being perpendicular to the axis (z10A, z10B, z10C) of the extra coil, and wherein
the headgear is designed to cover the user's head, in such a manner that the respective mean planes (P10B, P10C) of two coils, among said at least one coil, said additional coil and said extra coil, are perpendicular to the Frankfurt plane (PF) of the user's head, and form with the sagittal plane (PS) of the user's head pitch angles (βB, βC) comprised between 30 degrees and 60 degrees.

15. The measurement device (40) according to claim 1, wherein the shape or at least one dimension of said headgear (42) can be reversibly and elastically changed.

16. The measurement device (10; 40; 60; 70; 100) according to claim 1, further comprising a system (45) for calibrating the gyrometer.

17. The measurement device (10; 40; 60; 70; 100) according to claim 16, wherein the calibration system (45) comprise a display device (450) and a piloting unit (450) of the display device programmed to execute the following steps:
commanding the display device (450) to display a message inviting the user to make a rotational movement of the head,
determining an angle of rotation (α1, α1′; α2; α3_{G}) of the head, by integrating over time a measurement signal provided by the gyrometer during the rotational movement made by the user,
correcting a coefficient of calibration of the gyrometer as a function of the previously determined angle of rotation (α1, α1′; α2; α3_{G}).

18. The measurement device (10; 40; 60; 70; 100) according to claim 17, further comprising an image capturing device, and wherein the piloting unit (450) is further programmed to:
acquire a first image and a second image, captured by the image capturing device, before and after, respectively, said rotational movement of the head,
determine another angle of rotation (α3_{G}) by processing the first image and the second image, and to
correct the coefficient of calibration of the gyrometer as a function, also, of said other angle of rotation (α3_{G}).

19. The measurement device (10; 40; 60; 70; 100) according to claim 2, wherein a height (h1, h4, h5, h7) of said at least one coil (13; 43; 63; 73A, 73B, 73C; 103A, 103B, 103C) is smaller than 5 millimeters.

20. The measurement device (10; 40; 60; 70; 100) according to claim 2, wherein a height (h1, h4, h5, h7) of said at least one coil (13; 43; 63; 73A, 73B, 73C; 103A, 103B, 103C) is smaller than one tenth of an external diameter (Dext1; Dext6; Dext7) of said at least one coil.
